(19) United States
(12) Patent Application Publication
(10) Pub. No.: US 2026/0189828 A1
(43) Pub. Date: Jul. 2, 2026

(54) BUMPER FOR SPEAKER ASSEMBLY

(71) Applicant: Harman International Industries, Incorporated, Samford, CT (US)

(72) Inventors: Ming Wang, Shenzhen (CN); Jong-Ron Lo, Shenzhen (CN); Jianfeng Zhang, Shenzhen (CN)

(21) Appl. No.: 19/002,953

(22) Filed: Dec. 27, 2024

(51) Int. Cl. H04R 1/02

(52) U.S. Cl. CPC H04R 1/026

(57) ABSTRACT

A foot assembly for a speaker, the foot assembly may include a first portion having a first face configured to abut a surface external to the speaker, a second portion configured to interface with the first portion to create a hollow interior between the first and second portion, the second portion having a second face opposite the first face of the first portion, wherein the second face abuts the speaker, and a fill portion arranged within the hollow interior between the first and second portion to increase shock absorption and sound quality.

### TECHNICAL FIELD

Disclosed herein are bumper design for speaker assemblies.

### BACKGROUND

Speakers, especially portable speakers, as susceptible to easy movement when placed on surfaces, such as countertops, vehicles, boats, etc.

### SUMMARY

A foot assembly for a speaker, the foot assembly may include a first portion having a first face configured to abut a surface external to the speaker, a second portion configured to interface with the first portion to create a hollow interior between the first and second portion, the second portion having a second face opposite the first face of the first portion, wherein the second face abuts the speaker, and a fill portion arranged within the hollow interior between the first and second portion to increase shock absorption and sound quality.

A foot assembly for a speaker, the foot assembly may include a first portion having a first face configured to abut a surface external to the speaker, the first portion defined by a side forming a periphery of the first portion and defining a first open center between the side and the first face, and a second portion having a support extending around a periphery of the second portion and defining a second open center therebetween, wherein the side of the first portion is configured to receive the support of the second portion crating a hollow interior between the first and second portion sin an interfaced state.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a perspective exploded front view of a speaker assembly having a foot assembly;

FIG. 2 illustrates a perspective partial phantom view of the foot assembly of FIG. 1;

FIG. 3 illustrates a side view of the foot assembly of FIG. 2;

FIG. 4 illustrates a top view of the foot assembly of FIG. 3;

FIG. 5 illustrates a cross-sectional view of the foot assembly of FIG. 2;

FIG. 6 illustrates a perspective view of a first portion of the foot assembly of FIG. 2;

FIG. 7 illustrates a perspective view of a second portion of the foot assembly of FIG. 2; and

FIG. 8 illustrates a perspective view of the first and second portions in an installed or interfaced state to form the foot assembly of FIG. 2.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Disclosed herein is a speaker assembly have a foot assembly configured to increase shock absorption, having a better touch feeling for user experience and a better stereoscopic effect for a more enjoyable listening experience. The foot assembly also aids in a frictional engagement with a surface on which the speaker rests, which is especially beneficial in the field of portable speakers. The foot assembly includes two parts that are interfaced or attached via tooling and a third fill portion arranged inside the two parts that is bonded to at least one of the first and second parts via double injection. A hot melt film is arranged on a portion of the foot attached to the speaker assembly, and a plurality of ribs are included on the face configured to abut the surface. The foot assembly may be formed of silicone, both transparent and solid.

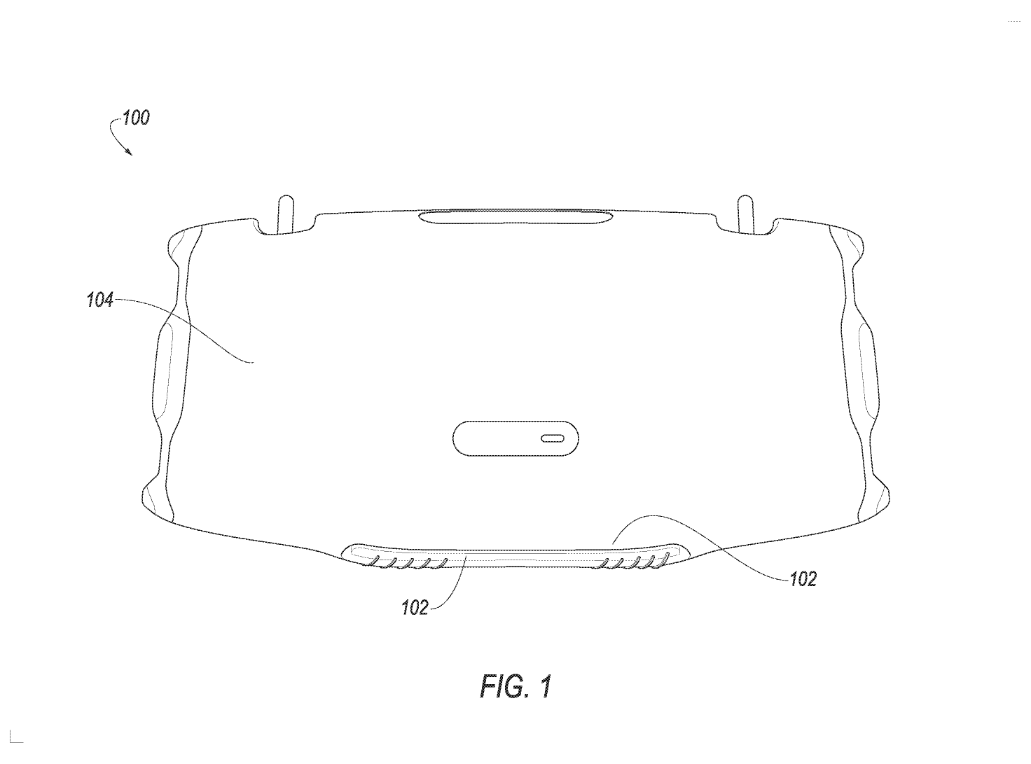

FIG. 1 illustrates a perspective exploded front view of a speaker assembly 100 having a foot assembly 102. The speaker assembly 100 may have a speaker body 104 and is configured to emit sound therefrom. The speaker assembly 100 may include diaphragms, cones, surrounds, voice coils, printed circuit boards and other electrical components. The example speaker assembly 100 discussed herein may be generally a portable speaker assembly, though the features disclosed may also be applicable to other speakers and even other electronic devices.

The foot assembly 102 may be installed a bottom of the speaker assembly 100. The foot assembly 102 may be configured to abut the surface upon which the speaker assembly 100 rests. The foot assembly may be formed of silicone, but other materials may be appreciated and are discussed in more detail herein. The foot assembly 102 may be installed within an opening 106 of the speaker assembly 100 where at least one surface of the foot assembly 102 is exposed via the opening.

It could be appreciated that more than one opening and foot assembly may be included in a speaker assembly 100. Because the foot assembly 102 is formed of a flexible material such as silicone, the foot assembly 102 may aid in creating friction engagement between the speaker assembly 100 and the surface on which it rests. Such friction may allow the speaker assembly 100 to remain in place, especially in examples where the speaker assembly 100 is used in moving vehicles, or in easily accessible areas such as a corner of a countertop, etc.

The foot assembly 102 also may aid in increasing shock absorption and may therefore also increase the sound quality of the speaker assembly 100. The foot assembly 102 may have a desirable surface to humans, as well as may have a better stereoscopic effect.

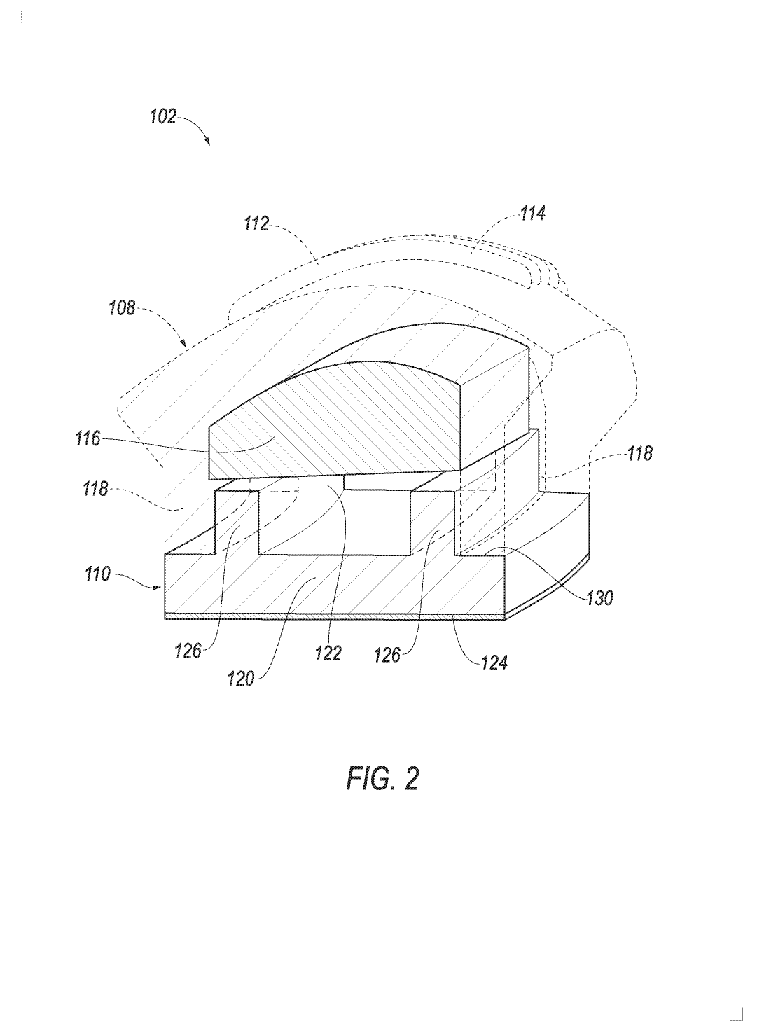

FIG. 2 illustrates a perspective partial phantom view of the foot assembly 102 of FIG. 1. The foot assembly 102 may include two portions, a first portion 108 and a second portion 110. The first portion 108 may define a first face 112 configured to interface or abut a surface external to the speaker assembly 100. The first face 112 may include a plurality of ribs 114 extending across at least a portion of the first face 112. The ribs 114 may be spaced from one another and be configured to provide additional friction against the surface to provide for better stability of the speaker assembly 100 thereon. The ribs 114 may be integral and part of the first portion 108.The first portion 108 may form an arch-like shape.

The first portion 108 is defined by a side 118 that extends from the first face 112 and forms the periphery of the first portion 108. The side 118 may form first open center within the first portion 108. The side 118 may be integral with the first face 112 and the first portion 108 may be formed of a single piece.

The first portion 108 may be formed of a silicon material, specifically in one example, a transparent silicone. Other synthetic polymers may be used, as well as rubber materials, thermoplastic elastomers (TPEs), etc.

A fill portion 116 is arranged within the first open center of the first portion 116. The fill portion 116 may extend within and along the first portion 108 between the side 118 and the first face 112 to fill the first open center therein. Similar to the first portion 108, the fill portion 116 may be made of silicone, though may be made of a solid colored silicone. The fill portion 116 may have a cross-section that mimics the curvature and side 118 of the first portion 116, generally filling the first open center entirely, or nearly entirely.

The second portion 110 may be configured to interface with the first portion 108 to form a hollow interior 122. The second portion 110 may have a second face 120 opposite the first face 112 of the first portion 108. The second face 120 may form a generally flat surface. A film 124, such as a hot melt film, heat activated adhesive film, or other adhesive film, may be disposed on the second face 112. The film 124 may be an adhesive to bond the foot assembly 102 to the speaker assembly 100. Such bonding may be achieved during manufacturing. The film 124 may be EVA (Ethylene Vinyl Acetate), TPU (Thermoplastic Polyurethane), PA (Polyamide), PES (Polyester), PO (Polyolefin, etc.

Other adhesives may also be used, such as glue, cement, epoxy, acrylic, polyurethane, cyanoacrylate, rubber-based adhesives, pressure-sensitive adhesives, water-based adhesives, silicone, UV-curing adhesives, anaerobic adhesives, etc.

The second portion 110 may include a support 126 extending upwards from the side opposite of the second face 120. The support 126 may form a cohesive ridge around the periphery of the second face 120, though inset a predefined amount leaving a ledge 130 at the perimeter of the second portion 110. Similar to the side 118 of the first portion 108, the support 126 of the second portion 110 forms a second open center therein.

When interfacing with the first portion 108, the support 126 of the second portion 110 may fit within the side 118 of the first portion 108. The support 126 may rest adjacent and inside the side 118 such that the side 118 rests on the ledge 130 of the second portion 110. The support 126 may extend to a predefined height such that the fill portion 116 rests on a top of the support 126. The second open center may remain open and configured to hold gas/air in the interfacing/installed state.

The second portion 110 may be formed of a silicon material, specifically in one example, a transparent silicone. Other synthetic polymers may be used, as well as rubber materials, thermoplastic elastomers (TPEs), etc.

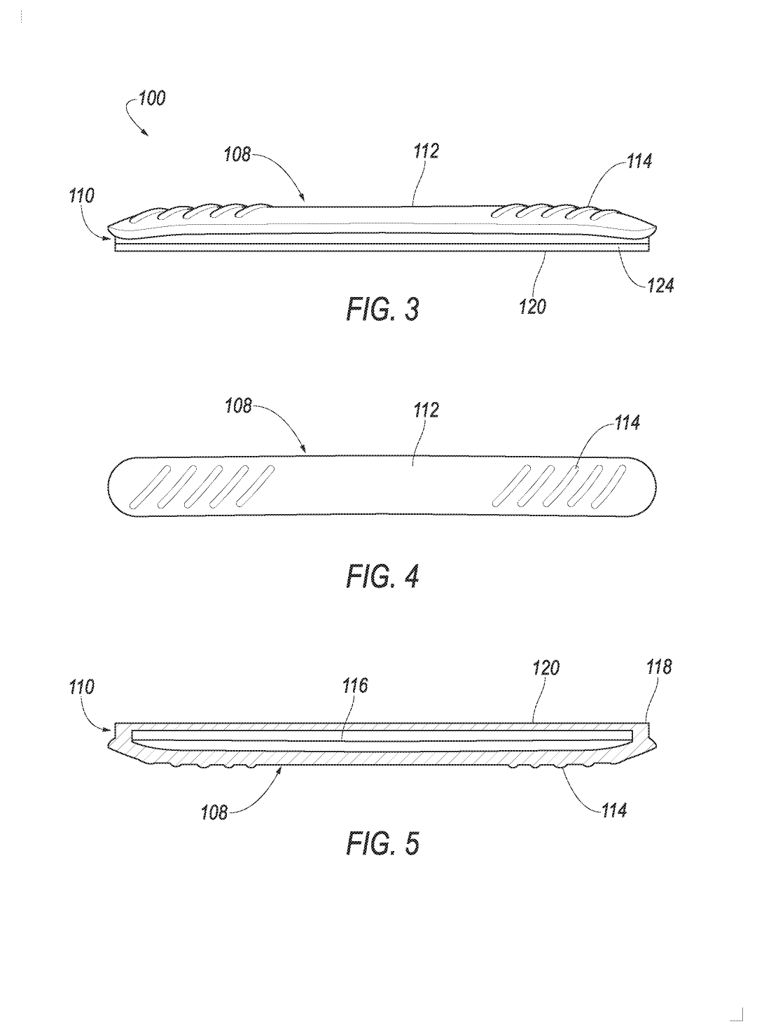

FIG. 3 illustrates a side view of the foot assembly of FIG. 2. FIG. 4 illustrates a top view of the foot assembly 102 of FIG. 3. FIG. 5 illustrates a cross-sectional view of the foot assembly 102 of FIG. 2.

As explained above, the foot assembly 102 includes the first portion 108 and the second portion 110 to form the foot assembly 102 in the installed or interfaced state. As best shown in FIG. 4, the plurality of ribs 114 may extend along a portion of the first face 112. In the example shown in the figures, the ribs are arranged in two sections towards each of the distal ends of the length of the foot assembly 102 with a space between the two sections. While four ribs are illustrated in each section, more or less ribs may be appreciated, as well as an alterative arrangement to the sections, more or less sections, etc.

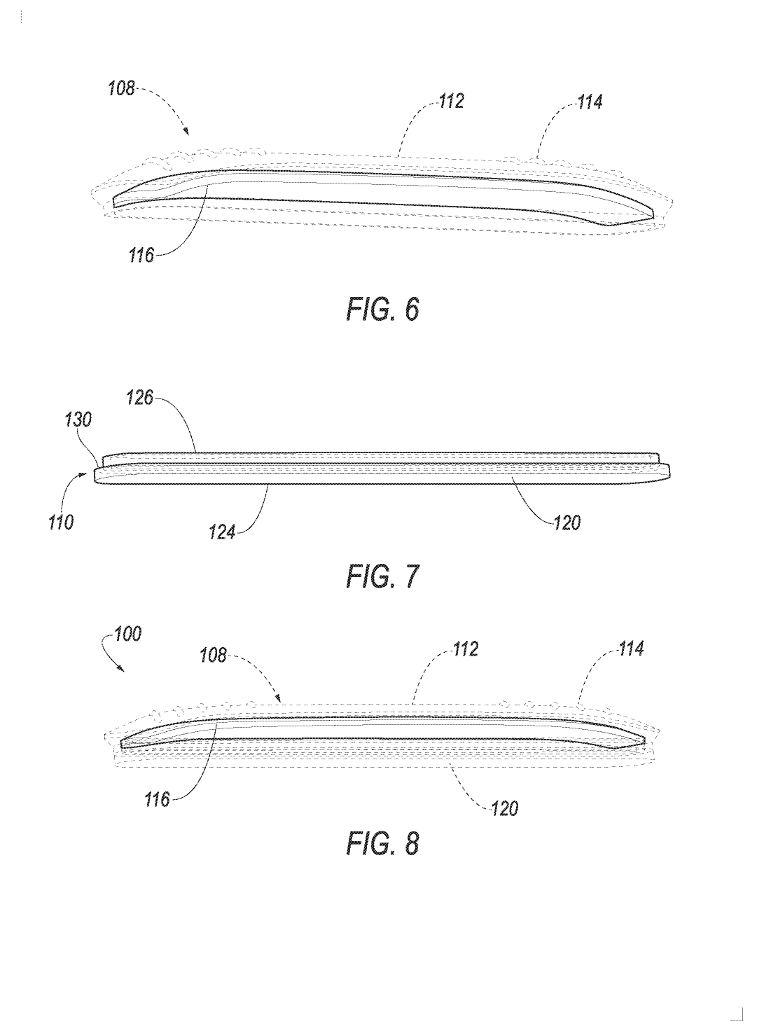

FIG. 6 illustrates a perspective view of a first portion of the foot assembly of FIG. 2. During assembly, the first portion 108 may be formed separate from the second portion 110. The fill portion 116 may be inserted into the first portion 108. As explained above, the first portion 108 may be formed of transparent silicone while the fill portion 110 may be formed of solid colored silicone. Each portion may be formed by injection molding and may be fully, or at least partially, cured prior to the fill portion 116 being inserted into the first portion 108.

The two portions may be bound by double injection, or two-shot molding. Alternatively, over molding may also be used. Once the first portion 108 and the fill portion 116 are assembled, the second portion 110 may be added.

FIG. 7 illustrates a perspective view of a second portion 110 of the foot assembly of FIG. 2. In this figure, the support 126 is shown as extending upward from the side opposite the second face 120 and film 124. The support 126 of the second portion 110 may be configured to fit within the side 118 of the first portion 108. The support 126 may rest adjacent and inside the side 118 such that the side 118 rests on the ledge 130 of the second portion 110. The support 126 may extend to a predefined height such that the fill portion 116 rests on a top of the support 126 (now shown in FIG. 7). The second open center may remain open and configured to hold gas/air in the interfacing/installed state.

FIG. 8 illustrates a perspective view of the first portion 108 and second portion 110 in an installed or interfaced state to form the foot 102 assembly of FIG. 2. The parts may be joined by various tooling.

Accordingly an improved foot assembly is disclosed herein, allowing for a cost effective and functional foot with better shock absorption and aesthetic feel.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A foot assembly for a speaker, the foot assembly comprising:
a first portion having a first face configured to abut a surface external to the speaker;
a second portion configured to interface with the first portion to create a hollow interior between the first and second portion, the second portion having a second face opposite the first face of the first portion, wherein the second face abuts the speaker; and
a fill portion arranged within the hollow interior between the first and second portion to increase shock absorption and sound quality.

2. The assembly of claim 1, further comprising an adhesive film arranged on the second surface.

3. The assembly of claim 1, wherein the first portion includes a side defining an outer periphery of the first portion and a first open center therein to create a portion of the hollow interior.

4. The assembly of claim 3, wherein the second portion includes a support extending form a periphery of the second portion and creating a second open center therein to create another portion of the hollow interior.

5. The assembly of claim 4, wherein the fill portion is received within the first open center of the first portion.

6. The assembly of claim 4, wherein the support of the second portion is configured to fit within the side of the first portion in an installed state.

7. The assembly of claim 6, wherein a top of the support abuts the fill portion in the installed state.

8. The assembly of claim 1, wherein the first portion is formed of transparent silicone.

9. The assembly of claim 1, wherein the second portion is formed of transparent silicone.

10. The assembly of claim 1, wherein the fill portion is formed of a solid silicone.

11. The assembly of claim 1, wherein the first face includes a plurality of ribs to create a friction engagement with the surface.

12. A foot assembly for a speaker, the foot assembly comprising:
a first portion having a first face configured to abut a surface external to the speaker, the first portion defined by a side forming a periphery of the first portion and defining a first open center between the side and the first face; and
a second portion having a support extending around a periphery of the second portion and defining a second open center therebetween,
wherein the side of the first portion is configured to receive the support of the second portion crating a hollow interior between the first and second portion sin an interfaced state.

13. The assembly of claim 12, further comprising a fill portion arranged within the first open center.

14. The assembly of claim 13, wherein a top of a support abuts the fill portion in the interfaced state.

15. The assembly of claim 13, wherein the fill portion is formed of solid color silicone.

16. The assembly of claim 13, wherein the first portion is formed of transparent silicone.

17. The assembly of claim 16, wherein the first portion and fill portion are bound by double injection.

18. The assembly of claim 12, wherein the second portion is formed of transparent silicone.

19. The assembly of claim 12, wherein the second portion includes a second face opposite the first face and further comprising a film arranged on the second face.

20. The assembly of claim 19, wherein the film is a heat activated adhesive film configured to attach the foot assembly to the speaker.
